(19) United States
(12) Patent Application Publication
(10) Pub. No.: US 2026/0292778 A1
(43) Pub. Date: Sep. 24, 2026

(54) DATA PROCESSING METHOD AND APPARATUS, DEVICE, AND READABLE STORAGE MEDIUM

(71) Applicant: VIVO MOBILE COMMUNICATION CO., LTD., Dongguan (CN)

(72) Inventors: Sihan CHENG, Dongguan (CN); Weiwei CHONG, Dongguan (CN); Hang YU, Dongguan (CN); Xiaobo WU, Dongguan (CN)

(21) Appl. No.: 19/682,662

(22) Filed: May 20, 2026

Related U.S. Application Data
(63) Continuation of application No. PCT/CN2024/133283, filed on Nov. 20, 2024.

(30) Foreign Application Priority Data
Nov. 21, 2023 (CN) 202311562812.0

(51) Int. Cl. H04W 64/00; H04L 41/16; H04W 8/22

(52) U.S. Cl. CPC H04W 64/00; H04L 41/16; H04W 8/22

(57) ABSTRACT

This application discloses a data processing method and apparatus, a device, and a readable storage medium, and pertains to the field of communication technologies. The data processing method in embodiments of this application includes: A first network element sends a first message to a second network element, where the first message is used to obtain location correlation data corresponding to a first area; and the first network element receives a second message from the second network element, where the second message includes the location correlation data corresponding to the first area.

### CROSS-REFERENCE TO RELATED APPLICATIONS

This application is a bypass continuation application of International Application No. PCT/CN 2024/133283, filed on Nov. 20, 2024, which claims the benefit of and priority to Chinese Patent Application No. 202311562812.0, filed with the China National Intellectual Property Administration on Nov. 21, 2023 and entitled “DATA PROCESSING METHOD AND APPARATUS, DEVICE, AND READABLE STORAGE MEDIUM”, the contents of both of which being incorporated by reference in their entireties herein.

### TECHNICAL FIELD

This application relates to the field of communication technologies and, more specifically, relates to a data processing method and apparatus, a device, and a readable storage medium.

### BACKGROUND

In an existing procedure, a network data analytics function (NWDAF) can only request and obtain location information of a single UE or a group of UEs, identified respectively by a terminal identifier (UE ID) or a group identifier (group ID), through communication over a channel involving a gateway mobile location center (GMLC), an access and mobility management function (AMF), and a location management function (LMF).

### SUMMARY

Embodiments of this application provide a data processing method and apparatus, a device, and a readable storage medium.

According to a first aspect, a data processing method is provided, including:

A first network element sends a first message to a second network element, where the first message is used to obtain location correlation data corresponding to a first area.

The first network element receives a second message from the second network element, where the second message includes the location correlation data corresponding to the first area.

According to a second aspect, a data processing method is provided, including:

A second network element receives a first message from a first network element, where the first message is used to obtain location correlation data corresponding to a first area.

The second network element sends a second message to the first network element, where the second message includes the location correlation data corresponding to the first area.

According to a third aspect, a data processing method is provided, including:

A fourth network element receives at least one of a fifth message or a seventh message from a second network element, where the fifth message is used to request cell information of location correlation data corresponding to a first area, and the seventh message is used to request identification information of a target terminal corresponding to the first area.

The fourth network element sends a sixth message to the second network element in a case of receiving the fifth message, where the sixth message includes the cell information corresponding to the location correlation data.

The fourth network element sends an eighth message to the second network element in a case of receiving the seventh message, where the eighth message includes the identification information of the target terminal.

According to a fourth aspect, a data processing method is provided, including:

A second network element sends a registration request to a third network element, where the registration request includes at least one of the following:
first capability information, indicating that the second network element has a data collection capability of supporting an area granularity;
second capability information, indicating that the second network element has a capability of supporting artificial intelligence AI positioning; and
information about an area supported by the second network element.

According to a fifth aspect, a data processing method is provided, including:

A first network element sends a third message to a third network element, where the third message is used to search for a second network element.

The first network element receives a fourth message from the third network element, where the fourth message includes address information and/or identification information of the second network element.

The second network element is configured to feed back location correlation data corresponding to a first area.

According to a sixth aspect, a data processing method is provided, including:

A third network element receives at least one of a third message from a first network element or a registration request from a second network element. The second network element is configured to feed back location correlation data corresponding to a first area; the third message is used to search for the second network element; and the registration request includes at least one of the following: first capability information, indicating that the second network element has a data collection capability of supporting an area granularity; second capability information, indicating that the second network element has a capability of supporting artificial intelligence AI positioning; and information about an area supported by the second network element.

The third network element sends a fourth message to the first network element in a case of receiving the third message, where the fourth message includes address information and/or identification information of the second network element.

According to a seventh aspect, a data processing apparatus is provided, including:
a first sending module, configured to send a first message to a second network element, where the first message is used to obtain location correlation data corresponding to a first area; and
a first receiving module, configured to receive a second message from the second network element, where the second message includes the location correlation data corresponding to the first area.

According to an eighth aspect, a data processing apparatus is provided, including:
a second receiving module, configured to receive a first message from a first network element, where the first message is used to obtain location correlation data corresponding to a first area; and
a second sending module, configured to send a second message to the first network element, where the second message includes the location correlation data corresponding to the first area.

According to a ninth aspect, a data processing apparatus is provided, including: a third receiving module, configured to receive at least one of a fifth message or a seventh message from a second network element, where the fifth message is used to request cell information of location correlation data corresponding to a first area, and the seventh message is used to request identification information of a target terminal corresponding to the first area;
a third sending module, configured to send a sixth message to the second network element in a case that the fifth message is received, where the sixth message includes the cell information corresponding to the location correlation data; and
a fourth sending module, configured to send an eighth message to the second network element in a case that the seventh message is received, where the eighth message includes the identification information of the target terminal.

According to a tenth aspect, a data processing apparatus is provided, including:
a fifth sending module, configured to send a registration request to a third network element, where the registration request includes at least one of the following:
first capability information, indicating that a second network element has a data collection capability of supporting an area granularity;
second capability information, indicating that a second network element has a capability of supporting artificial intelligence AI positioning; and information about an area supported by a second network element.

According to an eleventh aspect, a data processing apparatus is provided, including:
a sixth sending module, configured to send a third message to a third network element, where the third message is used to search for a second network element; and
a fourth receiving module, configured to receive a fourth message from the third network element, where the fourth message includes address information and/or identification information of the second network element.

The second network element is configured to feed back location correlation data corresponding to a first area.

According to a twelfth aspect, a data processing apparatus is provided, including:
a fifth receiving module, configured to receive at least one of a third message from a first network element or a registration request from a second network element, where the second network element is configured to feed back location correlation data corresponding to a first area; the third message is used to search for the second network element; and the registration request includes at least one of the following: first capability information, indicating that the second network element has a data collection capability of supporting an area granularity; second capability information, indicating that the second network element has a capability of supporting artificial intelligence AI positioning; and information about an area supported by the second network element; and
a seventh sending module, configured to send a fourth message to the first network element in a case that the third message is received, where the fourth message includes address information and/or identification information of the second network element.

According to a thirteenth aspect, a network device is provided. The network device includes a processor and a memory, the memory stores a program or instructions are executable by the processor, and the program or the instructions are executed by the processor to implement the steps of the method according to the first aspect, the steps of the method according to the second aspect, the steps of the method according to the third aspect, the steps of the method according to the fourth aspect, the steps of the method according to the fifth aspect, or the steps of the method according to the sixth aspect.

According to a fourteenth aspect, a network device is provided. The network device is a first network element and includes a processor and a communication interface. The communication interface is configured to send a first message to a second network element, and the first message is used to obtain location correlation data corresponding to a first area.

The communication interface is further configured to receive a second message from the second network element, and the second message includes the location correlation data corresponding to the first area.

According to a fifteenth aspect, a network device is provided. The network device is a second network element and includes a processor and a communication interface. The communication interface is configured to receive a first message from a first network element, and the first message is used to obtain location correlation data corresponding to a first area.

The communication interface is further configured to send a second message to the first network element, and the second message includes the location correlation data corresponding to the first area.

According to a sixteenth aspect, a network device is provided. The network device is a fourth network element and includes a processor and a communication interface. The communication interface is configured to send a first message to a second network element, the first message is used to receive at least one of a fifth message or a seventh message from a second network element, the fifth message is used to request cell information of location correlation data corresponding to a first area, and the seventh message is used to request identification information of a target terminal corresponding to the first area.

The communication interface is further configured to send a sixth message to the second network element in a case of receiving the fifth message, where the sixth message includes the cell information corresponding to the location correlation data.

The communication interface is further configured to send an eighth message to the second network element in a case of receiving the seventh message, where the eighth message includes the identification information of the target terminal.

According to a seventeenth aspect, a network device is provided. The network device is a second network element and includes a processor and a communication interface. The communication interface is configured to send a registration request to a third network element, and the registration request includes at least one of the following: first capability information, indicating that the second network element has a data collection capability of supporting an area granularity; second capability information, indicating that the second network element has a capability of supporting artificial intelligence AI positioning; and information about an area supported by the second network element.

According to an eighteenth aspect, a network device is provided. The network device is a first network element and includes a processor and a communication interface. The communication interface is configured to: send a third message to a third network element, where the third message is used to search for a second network element; and receive a fourth message from the third network element, where the fourth message includes address information and/or identification information of the second network element. The second network element is configured to feed back location correlation data corresponding to a first area.

According to a nineteenth aspect, a network device is provided. The network device is a third network element and includes a processor and a communication interface. The communication interface is configured to receive at least one of a third message from a first network element or a registration request from a second network element. The second network element is configured to feed back location correlation data corresponding to a first area; the third message is used to search for the second network element; and the registration request includes at least one of the following: first capability information, indicating that the second network element has a data collection capability of supporting an area granularity; second capability information, indicating that the second network element has a capability of supporting artificial intelligence AI positioning; and information about an area supported by the second network element.

The communication interface is further configured to send a fourth message to the first network element in a case of receiving the third message, where the fourth message includes address information and/or identification information of the second network element.

According to a twentieth aspect, a readable storage medium is provided. The readable storage medium stores a program or instructions. The program or the instructions are executed by a processor to implement the steps of the method according to the first aspect, the steps of the method according to the second aspect, the steps of the method according to the third aspect, the steps of the method according to the fourth aspect, the steps of the method according to the fifth aspect, or the steps of the method according to the sixth aspect.

According to a twenty-first aspect, a wireless communication system is provided, including a first network element, a second network element, a third network element, and a fourth network element. The first network element may be configured to perform the steps of the method according to the first aspect or the fifth aspect, the second network element may be configured to perform the steps of the method according to the second aspect or the fourth aspect, the third network element performs the steps of the method according to the sixth aspect, and the fourth network element performs the steps of the method according to the third aspect.

According to a twenty-second aspect, a chip is provided. The chip includes a processor and a communication interface, the communication interface is coupled to the processor, and the processor is configured to run a program or instructions to implement the steps of the method according to the first aspect, the steps of the method according to the second aspect, the steps of the method according to the third aspect, the steps of the method according to the fourth aspect, the steps of the method according to the fifth aspect, or the steps of the method according to the sixth aspect.

According to a twenty-third aspect, a computer program/program product is provided. The computer program/program product is stored in a storage medium, and the program/program product is executed by at least one processor to implement the steps of the method according to the first aspect, the steps of the method according to the second aspect, the steps of the method according to the third aspect, the steps of the method according to the fourth aspect, the steps of the method according to the fifth aspect, or the steps of the method according to the sixth aspect.

### BRIEF DESCRIPTION OF DRAWINGS

FIG. 1 is a block diagram of a wireless communication system;

FIG. 2 is a schematic flowchart 1 of a data processing method according to an embodiment of this application;

FIG. 3 is a schematic flowchart 1 of application of a data processing method according to an embodiment of this application;

FIG. 4 is a schematic flowchart 2 of application of a data processing method according to an embodiment of this application;

FIG. 5 is a schematic flowchart 3 of application of a data processing method according to an embodiment of this application;

FIG. 6 is a schematic flowchart 4 of application of a data processing method according to an embodiment of this application;

FIG. 7 is a schematic flowchart 2 of a data processing method according to an embodiment of this application;

FIG. 8 is a schematic flowchart 3 of a data processing method according to an embodiment of this application;

FIG. 9 is a schematic flowchart 4 of a data processing method according to an embodiment of this application;

FIG. 10 is a schematic flowchart 5 of a data processing method according to an embodiment of this application;

FIG. 11 is a schematic flowchart 6 of a data processing method according to an embodiment of this application;

FIG. 12 is a schematic diagram 1 of modules of a data processing apparatus according to an embodiment of this application;

FIG. 13 is a schematic diagram 2 of modules of a data processing apparatus according to an embodiment of this application;

FIG. 14 is a schematic diagram 3 of modules of a data processing apparatus according to an embodiment of this application;

FIG. 15 is a schematic diagram 4 of modules of a data processing apparatus according to an embodiment of this application;

FIG. 16 is a schematic diagram 5 of modules of a data processing apparatus according to an embodiment of this application;

FIG. 17 is a schematic diagram 6 of modules of a data processing apparatus according to an embodiment of this application;

FIG. 18 is a schematic diagram of a structure of a communication device according to an embodiment of this application; and

FIG. 19 is a schematic diagram of a structure of a network device according to an embodiment of this application.

### DETAILED DESCRIPTION

The following describes technical solutions in embodiments of this application with reference to accompanying drawings in embodiments of this application. Understandably, the described embodiments are merely a part rather than all of the embodiments of this application. All other embodiments obtained by a person of ordinary skill in the art based on embodiments of this application shall fall within the protection scope of this application.

The terms “first”, “second”, and the like in this application are used to distinguish between similar objects instead of describing a specified order or sequence. It should be understood that terms used in this way are interchangeable under appropriate circumstances, so that the embodiments of this application can be implemented in a sequence other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, a solution 1: including A and not including B; a solution 2: including B and not including A; and a solution 3: including both A and B. The character “/” generally represents an “or” relationship between associated objects.

The term “indication” in this application may be a direct indication (or an explicit indication), or may be an indirect indication (or an implicit indication). The direct indication may be understood as follows: A sender explicitly notifies, in a sent indication, a receiver of specific information, an operation that needs to be performed, a requested result, or other content. The indirect indication may be understood as follows: The receiver determines corresponding information based on the indication sent by the sender, or performs determining based on the indication sent by the sender, and determines, based on a determining result, the operation that needs to be performed or the requested result.

It should be noted that a technology described in the embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, or another system. The terms “system” and “network” are often used interchangeably in embodiments of this application. The technology described may be used for the systems and radio technologies described above, as well as other systems and radio technologies. The following describes a new radio (NR) system for illustrative purposes, and NR terms are used in most of the following descriptions. However, these technologies are also applicable to systems such as a 6^{th} generation (6G) communication system other than the NR system.

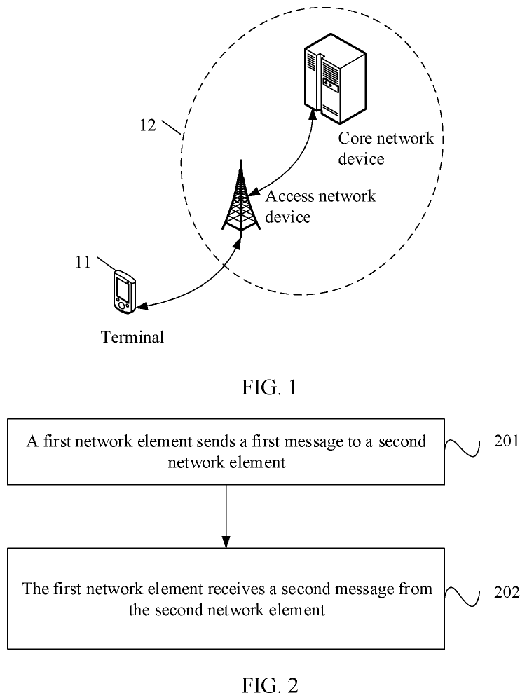

FIG. 1 is a block diagram of a wireless communication system applicable to an embodiment of this application. The wireless communication system includes a terminal 11 and a network device 12. The terminal 11 may be a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a flight vehicle, vehicle user equipment (VUE), ship-mounted equipment, pedestrian user equipment (PUE), a smart home (a home device with a wireless communication function, for example, a refrigerator, a television, a laundry machine, or a furniture), a gaming console, a personal computer (PC), a teller machine, a self-service machine, or another terminal-side device. The wearable device includes: a smartwatch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application. The network device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, and the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another proper term in the art. The base station is not limited to a specific technical term, provided that the same technical effect is achieved. It should be noted that in embodiments of this application, only a base station in an NR system is used as an example for description, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in embodiments of this application, only a core network device in an NR system is used as an example for description, and a specific type of the core network device is not limited.

For ease of understanding, some content related to embodiments of this application is described below.

### 1. NWDAF

The NWDAF is a network data analytics function network element that supports collecting data related to network elements or terminals and provides statistics and forecast information or the like. The NWDAF may collect data from network elements such as an AMF and an SMF or operation administration and maintenance (Operation Administration and Maintenance, OAM). The NWDAF obtains location information of a terminal through AMF collection. Herein, the location information of the terminal is of a coarse granularity, such as location information of a tracking area (TA) or a cell level. In other words, the NWDAF can learn, from the AMF, a cell or a TA in which the terminal is currently located.

If an NWDAF consumer sends a service request to the NWDAF to request the NWDAF to collect related information or provide a forecast, the NWDAF collects information from different network elements based on parameters in the request message. After the NWDAF performs statistics and analysis, the NWDAF returns a result to the NWDAF consumer.

### 2. Location Service (LCS)

The LCS is performed and provided by network elements such as the AMF and an LMF in a core network. An LCS message is exchanged between a user equipment (UE) and an LCS client or an application function (AF). A typical procedure is a mobile terminated location request (MT-LR).

The MT-LR procedure is initiated by an external third-party application (such as the LCS client) or by an AF through a NEF network element, to finally obtain location information of the UE through network elements such as a GMLC, the AMF, and the LMF.

The NWDAF can only request and obtain location information through a channel between the GMLC, the AMF, and the LMF, and data types such as measurement data are missing. In addition, data can be obtained only based on UE ID or group ID, causing low efficiency. As a result, the NWDAF cannot efficiently obtain sufficient data from the LMF.

In this application, a network element may be understood as a network function or a network device. For example, a first network element may also be referred to as a first network function or a first network device.

With reference to the accompanying drawings, a data processing method and apparatus, a device, and a readable storage medium that are provided in embodiments of this application are described in detail by using some embodiments and application scenarios thereof.

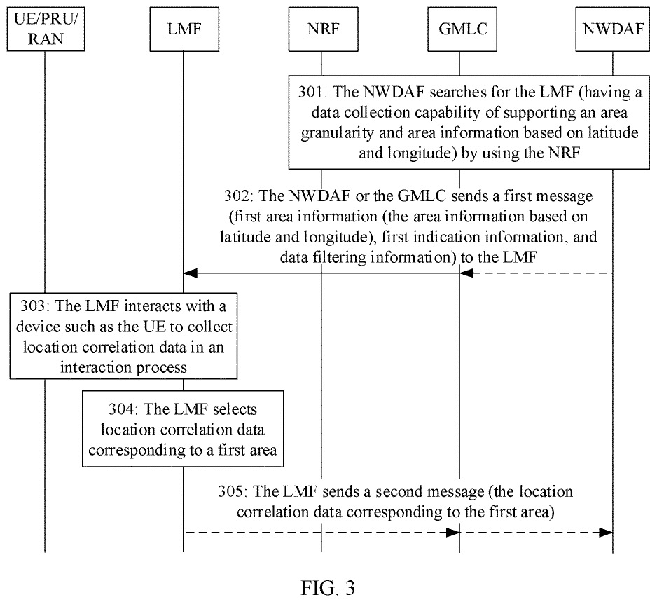

As shown in FIG. 2, a data processing method in an embodiment of this application includes the following steps.
Step 201: A first network element sends a first message to a second network element, where the first message is used to obtain location correlation data corresponding to a first area.
Step 202: The first network element receives a second message from the second network element, where the second message includes the location correlation data corresponding to the first area.

In this way, according to step 201 and step 202, the first network element that applies the data processing method in this embodiment of this application sends, to the second network element, the first message that is used to obtain the location correlation data corresponding to the first area, and receives the second message that is sent by the second network element and that includes the location correlation data corresponding to the first area, so as to obtain location correlation data of a specific area, thereby improving data processing efficiency.

In this embodiment of this application, in an optional implementation, the first network element may be a network element responsible for model training or model management, such as an NWDAF, an MTLF (Model Training logical function), or an AnLF (Analytics logical function), or a functional network element responsible for location correlation service management, such as a GMLC. The second network element may be a location management-related network element such as an LMF.

Optionally, the location correlation data corresponding to the first area includes location correlation data of a terminal in the first area. In an implementation, the location correlation data corresponding to the first area includes location correlation data of all terminals in the first area.

Optionally, in this embodiment, the first message includes at least one of the following:
area information of the first area;
first indication information, where the first indication information indicates passive data collection;
second indication information, where the second indication information indicates active data collection;
third indication information, where the third indication information indicates to collect the location correlation data corresponding to the first area;
an area granularity of the first area;
a message type, where the message type includes a subscription message or a request message;
data filtering information, where the data filtering information is used to limit reported location correlation data; and
a reporting condition of the location correlation data.

The area information of the first area indicates an area range. For example, the area information of the first area may be area information based on latitude and longitude (namely, area information of a latitude and longitude granularity), and the area information/area range based on latitude and longitude may be in a form of a geographical area description (GAD) shape, for example, including a shape (such as a rectangle) of a geographical area and a latitude and longitude description of the shape (such as latitude and longitude information of four corners of a rectangle). Alternatively, the area information of the first area may be area information based on a cell (namely, area information of a cell granularity), and may be indicated by using cell information (such as a cell identifier (cell ID)), a tracking area (TA) identifier, a TA list, or the like.

Optionally, the area information based on latitude and longitude may be referred to as the area information of a latitude and longitude granularity, and the area information based on a cell may be referred to as the area information of a cell granularity.

The first indication information included in the first message indicates the passive data collection, that is, indicates that the second network element does not need to perform an additional interaction for data collection. In other words, the first network element does not actively trigger an interaction, and collects location correlation data in a positioning process triggered by another device. For example, after receiving the first message, the second network element does not additionally trigger an interaction (for example, a positioning operation/a positioning interaction) due to the first message, but still performs an interaction (for example, a positioning interaction) based on a triggering condition, so as to collect location correlation data generated in an interaction process. The interaction process may occur at historical time, current time, or future time, and is determined based on the data filtering information.

Optionally, the passive data collection may also be referred to as passive data collection, non-active data collection, or data collection in a non-active trigger positioning manner.

It should be noted that the first indication information may be an explicit indication, or may be an implicit indication. In a case of an explicit indication, the first message needs to include the first indication information. In a case of an implicit indication, the first message does not need to include the first indication information, and the first indication information may be indicated by using a message name or other information associated with the first indication information.

The second indication information included in the first message indicates the active data collection, that is, indicates that the second network element needs to perform an additional interaction to collect location correlation data in an additional interaction process. For example, after receiving the first message, the second network element actively triggers an interaction (for example, a positioning operation/a positioning interaction) due to the first message, and further collects location correlation data generated in an interaction process. The interaction process may occur immediately after the first message is received, or may be triggered at a future time point or in a future time period, and is determined based on the data filtering information.

Optionally, the active collection may also be referred to as active data collection or data collection in an active trigger positioning manner.

It should be noted that the second indication information may be an explicit indication, or may be an implicit indication. In a case of an explicit indication, the first message needs to include the second indication information. In a case of an implicit indication, the first message does not need to include the second indication information, and the second indication information may be indicated by using a message name or other information associated with the second indication information.

The third indication information included in the first message indicates to collect the location correlation data corresponding to the first area, that is, indicates the second network element to collect corresponding location correlation data for a specific area, namely, the first area. If the first area is based on a latitude and longitude granularity, in other words, the first area is based on an area range limited by latitude and longitude information (for example, a GAD shape), the second network element collects location correlation data corresponding to the area range limited by the latitude and longitude information. If the first area is based on a cell granularity, in other words, the first area is based on an area range limited by cell information (for example, a cell or a TA), the second network element collects location correlation data corresponding to the area range limited by the cell information.

It should be noted that the third indication information may be an explicit indication, or may be an implicit indication. In a case of an explicit indication, the first message needs to include the third indication information. In a case of an implicit indication, the first message does not need to include the third indication information, and the third indication information may be indicated by using a message name or other information associated with the third indication information.

The first message includes the area granularity of the first area, and the area granularity of the first area indicates a granularity at which the first area is identified, or a granularity on which the area information of the first area is based. The area granularity of the first area may be the latitude and longitude granularity, or may be the cell granularity. Therefore, if the area granularity of the first area is the latitude and longitude granularity, the first area is identified based on the latitude and longitude information, or the area information of the first area is based on the latitude and longitude granularity, for example, the GAD shape. If the area granularity of the first area is the cell granularity, the first area is identified based on the cell information, or the area information corresponding to the first area is based on the cell granularity, for example, the cell and the TA.

It should be noted that the area granularity of the first area may be understood as an area granularity corresponding to the area information corresponding to the first area.

The first message includes the message type, that is, indicates whether the first message is the subscription message or the request message. Based on different message types of the first message, data reporting manner conditions, data collection methods, data filtering information, and the like may be different, and quantities and time of interactions of the second network element are also different.

In this way, the second network element may send, based on different message types of the first message, the second message in different manners (for example, triggering manners are different based on different data reporting manner conditions). For example, when the first message is the request message, the second network element feeds back/reports the location correlation data corresponding to the first area only once. When the first message is the subscription message, the second network element feeds back/reports the location correlation data corresponding to the first area a plurality of times within a subscription time period. If the reporting condition is periodic reporting, the second network element perform reporting when each periodicity is reached. If the reporting condition is event trigger reporting, the second network element triggers reporting when an event condition is satisfied, for example, performs reporting after collecting a specific amount of data based on a data amount, or performs data reporting based on time, for example, at specific time (which may be time or fixed time, such as next Monday or each Monday).

It should be noted that the message type may be an explicit indication, or may be an implicit indication. In a case of an explicit indication, the first message needs to include information indicating the message type of the first message, for example, the first message includes information indicating that the first message is a subscription message or a request message. In a case of an implicit indication, the first message does not need to include information indicating the message type of the first message, and the message type may be indicated by using a message name or other information associated with the message type.

The first message includes the data filtering information, that is, a condition required for notifying or limiting location correlation data fed back by the second network element.

It should be noted that the data filtering information is used to limit the requested location correlation data, or may be referred to as data filtering information, location correlation data filtering information, location correlation data filtering information, or the like. Optionally, the data filtering information is used to limit a data source type (a target data source type) of the requested location data, time information (target time information) corresponding to the requested location data, and/or a data type (a target data type) corresponding to the requested location data, where the time information corresponding to the location data may be generation time or obtaining time of the location data.

Optionally, the data filtering information may also be directly referred to as filtering information, but appears in a context as filtering information for location correlation data.

It should be noted that in this application, location correlation data and location data have similar meanings and may be replaced with each other.

The first message includes the reporting condition, and the reporting condition is used to notify the second network element of a method, a condition, or the like for reporting the location correlation data corresponding to the first area, for example, periodic reporting, or event trigger reporting (for example, time is reached, or a data amount requirement is satisfied). Periodic reporting means that the second network element needs to report data at intervals, or performs reporting after collecting a specific amount of data based on a data amount, or performs data reporting based on time, for example, at specific time (which may be time or fixed time, such as next Monday or each Monday).

Optionally, in this embodiment, if the first message is the subscription message, the first message further includes at least one of the following:
subscription condition information, where the subscription condition information indicates information such as a condition and a limitation of subscription, for example, subscription time information, indicating that subscription is performed within a period of time; and
notification target address information (Notification Target Address(es)), where the notification target address information indicates an address of a subscription target, such as a network element address of the NWDAF; or a correlation ID (such as a notification correlation identifier (Notification Correlation ID) or a subscription correlation identifier (subscription correlation ID)), indicating an association with a subscription message.

Certainly, the first message may implicitly indicate, by using the subscription condition information or the notification target address information, that the type of the first message is the subscription message.

Optionally, in this embodiment, the data filtering information includes at least one of the following:
a target data source type;
target time information; and
a target data type.

The target data source type indicates a device for generating data and a data source, and may refer to a network device, such as a UE/PRU/RAN.

Optionally, the target data source type indicates location correlation data generated by the PRU; or the target data source type indicates location correlation data generated by the UE or the LMF; or the target data source type indicates location correlation data generated by a RAN node.

The target time information indicates time corresponding to the location correlation data, such as time at which data is generated. Specifically, the target time information indicates, for example, a past time period, a future time period, or a specific time point.

The target data type may also be referred to as a target data type of location correlation data, and is a data type that needs to be satisfied for the location correlation data corresponding to the requested first area.

Optionally, the target data type may include at least one of the following:
measurement data; location data; intermediate feature data; and assistance data.

The measurement data is data used for measurement in a positioning process. A device such as the UE or the LMF may perform calculation based on the measurement data, so as to obtain location data. The measurement data includes at least one of the following: a channel impulse response (CIR), a power delay profile (PDP), and a delay profile (DP). The PDP includes at least one of the following: reference signal received power (RSRP), reference signal received power path (RSRPP), and a reference signal time difference (RSTD).

The location data may include a geodetic location, a civic location, or the like.

In other words, a location defined by the location data may be a geographic location, a latitude and longitude location, a cell coverage location, a city coverage location, or the like.

The intermediate feature data refers to data generated by a device such as a UE/positioning reference unit (PRU)/RAN in a process of processing the measurement data, and may be generated by processing the measurement data based on some algorithms or models. The intermediate feature data may include time of arrival (TOA), a path phase, or the like.

The assistance data refers to some positioning assistance data, for example, information such as radio signaling configuration information, reference cell information, neighboring cell information, and a search time window of the RSTD. The assistance data may further include reference signal configuration (RS configuration) or the like.

It should be noted that a data category and a data type may appear separately or simultaneously. For example, the data category appears separately, that is, the measurement data, the intermediate feature data, and the like; the data type appears separately, that is, the CIR, the PDP, the RS configuration information, and the like; or the data category and the data type appear simultaneously, that is, the measurement data, the CIR, the measurement data, the PDP, the intermediate feature data, the TOA, and the like.

Optionally, in this embodiment, the second message includes the location correlation data corresponding to the first area, which may be referred to as a data value, and refers to information such as a number represented by the data.

It should be noted that there may be at least one piece of location correlation data, for example, at least one piece of location correlation data or at least one item of location correlation data.

Optionally, in this embodiment, the second message further includes at least one of the following:
a data type corresponding to the location correlation data;
time information corresponding to the location correlation data;
a data source corresponding to the location correlation data;
area information corresponding to the location correlation data; and
identification information of a terminal.

The data type that corresponds to the location correlation data and that is included in the second message is a data type corresponding to the at least one piece of location correlation data reported by the second network element, such as the measurement data, the location data, the intermediate feature data, and the assistance data; or may be a specific data type, such as the RSRP, the PDP, and the CIR; or may be a combination of the two, such as the measurement data, the CIR, and indication GNSS data.

The time information that corresponds to the location correlation data and that is included in the second message is time corresponding to the at least one piece of location correlation data reported by the second network element, such as time generated by the data, or data collection time.

The data source that corresponds to the location correlation data and that is included in the second message is a data source corresponding to the at least one piece of location correlation data reported by the second network element, such as the PRU, the UE, the LMF, and the RAN. The data source is specifically indicated by using a device identifier.

The area information that corresponds to the location correlation data and that is included in the second message is area information corresponding to the at least one piece of location correlation data reported by the second network element, for example, area information based on the latitude and longitude granularity.

The identification information of the terminal included in the second message is, for example, a UE ID, a user permanent identifier (SUPI), or an international mobile equipment identity (IMEI), or may be a terminal identifier that is processed (the AMF does not directly expose the UE ID, but maps to another identifier), such as a location service correlation identifier (LCS correlation ID).

The second message includes information about an identifier of an access network node, for example, an identifier of a base station. The information indicates specific access network nodes related to the location correlation data. These access network nodes are access network nodes to which a terminal in the first area belongs.

Optionally, in this embodiment, that a first network element sends a first message to a second network element may be that the first network element directly sends the first message to the second network element, and the first message does not need to be forwarded by another network element. Correspondingly, that the first network element receives a second message sent by the second network element may be that the second network element directly sends the second message to the first network element, and the second message does not need to be forwarded by another network element.

Optionally, in this embodiment, that a first network element sends a first message to a second network element includes:

The first network element sends the first message to the second network element via a fifth network element.

That the first network element receives a second message from the second network element includes:

The first network element receives the second message from the second network element via the fifth network element.

In this way, the first network element sends the first message to the fifth network element, and the fifth network element sends the first message to the second network element. Correspondingly, the second network element sends the second message to the fifth network element, and the fifth network element sends the second message to the first network element. In this case, the first network element may be the NWDAF, the fifth network element may be the GMLC, and the second network element may be the LMF. The NWDAF may send the first message to the GMLC by using a service such as a Ngmlc_Location_ProvideLocation.

It should be noted that when the fifth network element sends the first message to the second network element, sent information may not be completely consistent, for example, a sent subscription address may be address information of the fifth network element instead of address information of the first network element (because the LMF may still be unable to directly interact with the NWDAF).

Optionally, in this embodiment, that a first network element sends a first message to a second network element may be that the first network element receives the first message from a sixth network element, and sends the first message to the second network element. Correspondingly, the first network element receives the second message from the second network element, and sends the second message to the sixth network element. In this case, the first network element may be the GMLC, the sixth network element may be the NWDAF, and the second network element may be the LMF.

It should be understood that, the second network element, such as the LMF, interacts with the device such as the UE/PRU/RAN, to generate location correlation data. Specifically, the second network element interacts with the device such as the UE/RAN/PRU before or after receiving the first message, for example, performs a positioning procedure, to obtain location correlation data, including historical data or future data. For example, in a positioning interaction process, the second network element obtains measurement data and/or intermediate feature data of the UE/RAN/PRU, or obtains data such as location information of the UE/PRU. Alternatively, the second network element first interacts with the device such as the RAN before performing positioning, to obtain some assistance data or the like.

Certainly, the foregoing interaction may also be performed before feedback time (time of sending the second message).

In addition, triggering of these interactions may be based on triggering of another device, such as the UE, the RAN, and another LCS client. For example, another device carrying information such as the UE ID and the LCS correlation ID sends a request to the second network element, to request the second network element to obtain location information of a device corresponding to the UE ID and the LCS correlation ID. After receiving these requests, the second network element triggers an interaction, such as a positioning procedure, to obtain location information and other location correlation data.

In an optional implementation, message types of the first message are different, data reporting manner conditions are different, data collection methods are different, data filtering information is different, and the like, so that quantities and time of interactions of the second network element are also different. For example, the target time information in the data filtering information is a past time period, and the second network element selects, based on data obtained through historical interaction, location correlation data carried in the second message. For example, the second network element may locally store historical location correlation data (for example, recent, short-term, half-year, or long-term location correlation data), and select, after receiving the first message (a message type is a request message), data that satisfies information such as the data filtering information for reporting. Alternatively, the target time information in the data filtering information is a future time period, and the second network element selects, based on data obtained through future interaction, location correlation data carried in the second message. For example, the second network element receives the first message (a message type is a request message), and the second network element selects, from the data obtained through interaction (interaction with the device such as the UE after the first message) in a future time period, data that satisfies information such as the data filtering information for reporting.

In this embodiment, the location correlation data that corresponds to the first area and that is included in the second message may be referred to as target data. Specifically, the second network element selects, based on content in the first message, for example, the data filtering information, the area information of the first area, and the like, data that satisfies a condition as the target data.

It should be noted that message types of the first message are different, data filtering information is different, and the like, so that the second network element may select the target data at different time and in different manners. For example, the message type of the first message is the request message, the target time information in the data filtering information is a past time period, and the second network element selects, based on the data obtained through historical interaction, the location correlation data carried in the second message. For example, the second network element may locally store the historical location correlation data (such as the recent, short-term, half-year, or long-term location correlation data), and selects, after receiving the first message (the message type is the request message), the data that satisfies the information such as the data filtering information for reporting. Alternatively, the message type of the first message is the request message, the target time information in the data filtering information is a future time period, and the second network element selects, based on the data obtained through future interaction, the location correlation data carried in the second message. For example, the second network element receives the first message (the message type is the request message), and the second network element selects, from the data obtained through interaction (interaction with the device such as the UE after the first message) in a future time period, the data that satisfies the information such as the data filtering information for reporting. Alternatively, the message type of the first message is the subscription message, the target time information in the data filtering information is a future time period, and the second network element selects, based on data obtained through future interaction, the location correlation data carried in the second message. For example, the second network element receives the first message (the message type is the subscription message), and the second network element selects, from the data obtained through interaction (interaction with the device such as the UE after the first message) in a future time period, the data that satisfies the information such as the data filtering information for reporting.

Optionally, in this embodiment, that the second network element selects the data that satisfies the data filtering information may be implemented in a manner of determining whether information about the collected data matches the data filtering information, for example, whether a location of the collected data is in the area information, that is, in the area range; whether a generation device of the collected data matches the target data source type; whether generation time of the collected data matches the target time information, or is within a target time period (a time period indicated by the target time information); or whether a data type of the collected data matches the target data type.

In the foregoing content, the second network element may learn location information of a device after performing an interaction. However, the second network element may obtain only geographic location information (or location information based on latitude and longitude) instead of location information of a cell ID granularity (location information of a cell granularity). Therefore, an additional manner is further required to convert the geographic location information into the location information of the cell granularity. Optionally, in this embodiment of this application, either of the following two manners may be used:
Manner 1: The UE is enhanced. When reporting location information, the UE simultaneously reports cell information (for example, a cell ID) corresponding to the UE. It should be noted that simultaneous reporting of the cell information by the UE may be a capability of the UE, that is, the UE decides to report information such as the cell ID when performing an interaction such as positioning. Alternatively, when performing requesting, the second network element simultaneously requests the UE to report the geographic location information and the location information of the cell granularity.
Manner 2: The second network element sends a fifth message to a fourth network element (such as the AMF), and the fourth network element determines, based on the fifth message, cell information corresponding to the location correlation data, and sends a sixth message to the second network element, where the sixth message includes the cell information. The fifth message is used to request the cell information corresponding to the location correlation data, and may be understood as requesting to convert geographic location information of the location correlation data. Herein, the location correlation data corresponding to the fifth message may be the location correlation data corresponding to the first area, In other words, the second network element determines the location correlation data corresponding to the first area, and requests the cell information of the location correlation data from the fourth network element. The location correlation data corresponding to the fifth message may alternatively be location correlation data collected in an interaction process, In other words, the second network element requests the cell information of the location correlation data from the fourth network element for the collected location correlation data, and then determines the location correlation data corresponding to the first area.

Optionally, the fifth message includes at least one of the following:
latitude and longitude location information corresponding to the location correlation data;
a target area granularity; and
fourth indication information, where the fourth indication information indicates to determine the cell information corresponding to the location correlation data.

Herein, the latitude and longitude location information corresponding to the location correlation data may be understood as a latitude and longitude location of a terminal corresponding to the location correlation data.

It should be noted that the latitude and longitude location information corresponding to the location correlation data is converted source information, namely, information that needs to be converted, or needs to be converted or determined based on the information or cell information. The target area granularity indicates a specific granularity of conversion, may be a cell ID granularity, a TA granularity, or the like, and may be specifically determined based on the area granularity in the first message. The fourth indication information indicates to determine the cell information corresponding to the location correlation data, that is, indicates the fourth network element to perform a conversion operation, so as to convert location information into cell information, or indicates the fourth network element to determine, based on location information, an internal mapping relationship, or the like, cell information corresponding to the location information. The determined cell information may be based on the target area granularity. To be specific, if the target area granularity is a TA granularity or the like, the fourth indication information may alternatively indicate to determine TA information corresponding to the location correlation data.

In this way, if the second network element collects, based on the first message, latitude and longitude location information of five groups of location correlation data for a first cell, and sends the latitude and longitude location information of the five groups of location correlation data, the fourth indication information, and the target area granularity (for example, the cell ID granularity) to the fourth network element via the fifth message, the fourth network element can convert the latitude and longitude location information into cell IDs. If the fifth message does not include the target area granularity, the fourth network element may perform conversion based on a default area granularity.

It should be noted that the target area granularity may be an explicit indication, or may be an implicit indication. In a case of an explicit indication, the fifth message needs to include the target area granularity. In a case of an implicit indication, the fifth message does not need to include the target area granularity, for example, the target area granularity may be indicated by using information such as a message name. The fourth network element determines a converted target area granularity based on the fifth message sent by the second network element.

It should be noted that how the fourth network element converts the location information (based on the latitude and longitude) into the location information of the cell granularity is not limited herein, which is an internal logic and implementation of the fourth network element. For example, the location information of the cell granularity or the like may be determined based on the internal mapping relationship of the fourth network element.

Optionally, in this embodiment, the second network element sends a seventh message to the fourth network element. The seventh message is used to request identification information of a target terminal corresponding to the first area. After receiving the seventh message, the fourth network element determines, based on the seventh message, the identification information of the target terminal corresponding to the first area, and sends an eighth message to the second network element, where the eighth message includes the identification information of the target terminal.

The target terminal corresponding to the first area may be understood as a terminal that belongs to the first area. Optionally, the target terminal belongs to the first area at specific time (for example, the time indicated by the target time information or sending time of the first message).

Optionally, the second network element determines to actively collect data, for example, based on the received first message that is from the first network element and that includes the second indication information. Then, the second network element sends the seventh message to the fourth network element, to request the identification information of the target terminal corresponding to the first area.

Optionally, the first message may further include the identification information of the target terminal. For example, before sending the first message, the first network element or the fifth network element obtains the identification information of the target terminal corresponding to the first area, and sends the identification information of the target terminal to the second network element.

In this way, before selecting the location correlation data corresponding to the first area, the second network element may collect location correlation data of the corresponding terminal for the identification information of the target terminal in a data collection process by learning the identification information of the target terminal corresponding to the first area. In this way, the collected location correlation data is the location correlation data corresponding to the first area. In this way, there is no other setting for the data filtering information of the first message, and the second network element may directly send the collected data to the first network element via the second message. Optionally, in this embodiment, the second network element sends a registration request to a third network element, where the registration request includes at least one of the following:
first capability information, indicating that the second network element has a data collection capability of supporting an area granularity;
second capability information, indicating that the second network element has a capability of supporting artificial intelligence AI positioning; and
information about an area supported by the second network element. That is, in a registration process, the second network element can register capability information of the second network element with the third network element, and information carried in the registration request may be referred to as network element registration information of the second network element. The information about the area supported by the second network element may be understood as area information supported by the second network element, and may be a service range covered by the second network element, such as the GAD shape, the cell ID, and the TA. The first capability information indicates that the second network element has the data collection capability of supporting the area granularity, that is, the second network element has a data collection capability of supporting the latitude and longitude granularity and/or the cell granularity, or the second network element has a data collection capability of supporting a geographic area. The second capability information indicates that the second network element has the capability of supporting artificial intelligence AI positioning, that is, the second network element has a capability of supporting AI positioning.

The registration request may further include other information of the second network element, for example, capability information indicating that the second network element has an active collection capability, or a time range in which the second network element supports data collection. The active collection capability is supported, that is, the second network element has a capability of supporting actively triggering positioning-related interaction and collecting data in an interaction process. The time range for supporting data collection may indicate that the second network element supports data collection within a specific time range, for example, supports historical data collection, so as to indicate whether the second network element can retain historical data.

It should be noted that AI positioning is a capability of introducing AI in a positioning process. For example, a communication device such as the UE/RAN/LMF processes the measurement data and/or the intermediate feature data and/or assistance information by using an AI/machine learning (ML) model, so as to obtain the intermediate feature data or positioning result data (such as location information).

Optionally, after receiving the registration request, the third network element stores the network element registration information of the second network element carried in the registration request, and feeds back a response message to the second network element, to notify the second network element that registration succeeds. Optionally, in this embodiment, before the first network element sends the first message to the second network element, the first network element determines the second network element based on a local configuration, a request message of the sixth network element, or the like, so as to send the first message to the second network element.

Optionally, in this embodiment, before the first network element sends the first message to the second network element, the method further includes:

The first network element sends a third message to the third network element, where the third message is used to search for the second network element.

The first network element receives a fourth message from the third network element, where the fourth message includes location information and/or identification information of the second network element.

Herein, the address information of the second network element included in the fourth message may be an IP address. The identification information of the second network element included in the fourth message may be an NF instance ID, an FQDN or IP address of NF, network element instance identification information, or the like. The third network element may be an NRF, and the first network element may be the NWDAF or the GMLC. For example, when the GMLC receives the first message from the NWDAF, the GMLC performs a network element search, and sends the third message to the NRF.

Optionally, the third message is implemented by using a service such as a network element discovery request or an Nnrf_NFDiscovery_Request service, and the fourth message is implemented by using a service such as an Nnrf_NFDiscovery_Request response.

Optionally, the third message includes at least one of the following:
area information of a target network element;
sixth indication information, where the sixth indication information indicates that a target network element needs to have a data collection capability of supporting an area granularity; and
seventh indication information, where the seventh indication information indicates that a target network element needs to have a capability of supporting artificial intelligence AI positioning.

The target network element is a searching target of the third message.

In this way, the first network element can find, based on the foregoing content of the third message by using the third network element, the target network element that satisfies a condition, where the target network element includes the second network element. The area information of the target network element indicates area information supported by a target network element (the second network element) that is expected to be searched, such as GAD shape information, cell ID information, and TA information. The area information of the target network element may be the same as or different from the area information of the first area, and the area information of the target network element may be of a latitude and longitude granularity or a cell granularity. When the third message includes the sixth indication information, the sixth indication information indicates that the target network element (the second network element) expected to be searched by the first network element has a capability of supporting data collection of a latitude and longitude granularity and/or a cell granularity, or indicates that the target network element (the second network element) expected to be searched has a capability of supporting data collection in a geographical area. When the third message includes the seventh indication information, the seventh indication information indicates that the target network element (the second network element) expected to be searched by the first network element has a capability of supporting AI positioning.

Certainly, the third message may further include another indication about the target network element, such as an indication of supporting an active collection capability, a time range for supporting data collection, and a network element type of the target network element (the second network element) expected to be searched. The time range indicates historical time (namely, a time period or a time point before the third message is sent), and it indicates that the target network element (the second network element) expected to be searched has a capability of retaining historical data.

Optionally, after receiving the third message, the third network element searches for the target network element, namely, the target second network element, by matching the stored network element registration information with information carried in the third message. After finding the target second network element of the first network element, the third network element sends the fourth message to the first network element, where the fourth message carries the address information and/or the identification information of the second network element.

Certainly, similar to the first message, that the first network element sends a third message to the third network element may be that the first network element directly sends the third message to the third network element, and the third message does not need to be forwarded by another network element. Correspondingly, that the first network element receives the fourth message sent by the third network element may be that the third network element directly sends the fourth message to the first network element, and the fourth message does not need to be forwarded by another network element.

Alternatively, that the first network element sends a third message to the third network element is that the first network element sends the third message to the third network element via the fifth network element; and the first network element receives, by using the fifth network element, the fourth message sent by the third network element. In this way, the first network element sends the third message to the fifth network element, and the fifth network element sends the third message to the third network element. Correspondingly, the third network element sends the fourth message to the fifth network element, and the fifth network element sends the fourth message to the first network element. In this case, the first network element may be the NWDAF, the fifth network element may be the GMLC, and the second network element may be the LM.

The following describes application of embodiments of this application with reference to specific scenarios.
Scenario 1: Area information based on a latitude and longitude granularity and passive collection

As shown in FIG. 3, a specific implementation procedure includes the following steps.
Step 301: An NWDAF searches for an LMF by using an NRF, to search for an LMF that has a data collection capability of supporting an area granularity and supporting area information based on latitude and longitude.

Optionally, in manner 1, the NWDAF directly sends a third message to the NRF, and the NRF searches for the LMF and sends a fourth message to the NWDAF. In manner 2, the NWDAF sends a request message to a GMLC, the GMLC sends a third message to the NRF, and the NRF searches for the LMF and sends a fourth message to the GMLC.
Step 302: The NWDAF or the GMLC sends a first message to the LMF (a target LMF, or the LMF found in step 301), where the first message includes area information (area information based on latitude and longitude) of a first area, first indication information, and data filtering information.
Step 303: The LMF interacts with a device such as a UE/PRU/RAN to collect location correlation data in an interaction process.
Step 304: The LMF selects, based on the first message, location correlation data corresponding to the first area.

Optionally, the LMF selects, based on the area information of the first area and the data filtering information that are in the first message, target data that satisfies a condition, namely, the location correlation data corresponding to the first area.
Step 305: The LMF sends a second message, and feeds back the location correlation data corresponding to the first area to the NWDAF.

Optionally, the LMF sends the second message to the GMLC, and the GMLC sends the second message to the NWDAF, or the like. Specifically, the LMF collects data based on the first message and sends data that satisfies a condition to the GMLC. The GMLC feeds back the data to the NWDAF or the like, for example, by using a Ngmlc_Location_ProvideLocation Response.

Optionally, the LMF directly sends the second message to the NWDAF.

In a case that the first message is a subscription message, the LMF may directly send the second message to a device such as the NWDAF or the GMLC based on information such as address information of a notification target in the subscription message.
Scenario 2: Area information based on cell information and passive collection

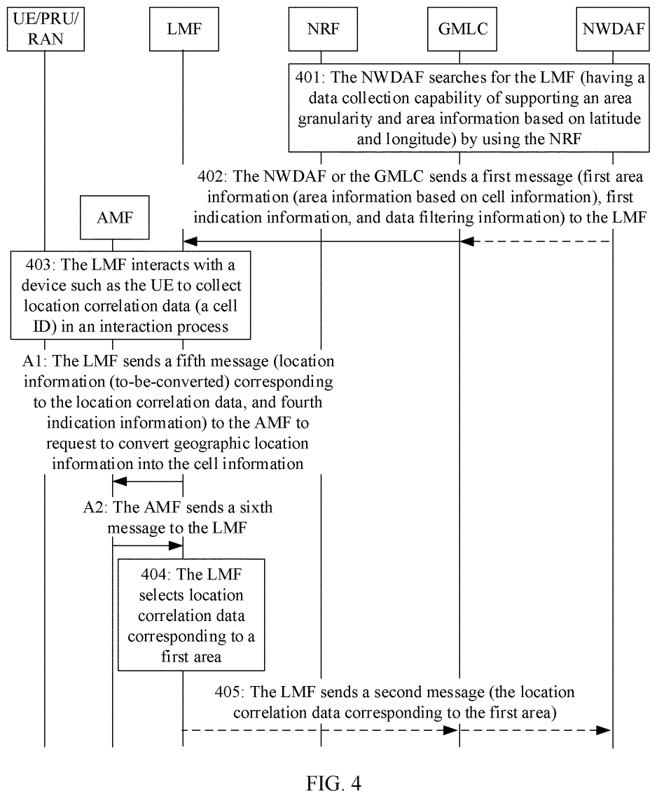

As shown in FIG. 4, a specific implementation procedure includes the following steps.
Step 401: An NWDAF searches for an LMF by using an NRF, to search for an LMF that has a data collection capability of supporting an area granularity and supporting area information based on latitude and longitude.

Optionally, in manner 1, the NWDAF directly sends a third message to the NRF, and the NRF searches for the LMF and sends a fourth message to the NWDAF. In manner 2, the NWDAF sends a request message to a GMLC, the GMLC sends a third message to the NRF, and the NRF searches for the LMF and sends a fourth message to the GMLC.

Optionally, the third message is implemented by using a service such as an Nnrf_NFDiscovery_Request service, and the fourth message is implemented by using a service such as an Nnrf_NFDiscovery_Request response.
Step 402: The NWDAF or the GMLC sends a first message to the LMF (a target LMF, or the LMF found in step 401), where the first message includes area information (area information based on cell information) of a first area, first indication information, and data filtering information.

Optionally, the area information of the first area is a cell ID, a TA List, or a TA ID.
Step 403: The LMF interacts with a device such as UE/PRU/RAN to collect location correlation data in an interaction process.

Optionally, the LMF may obtain only geographic location information (or the area information based on latitude and longitude) instead of the area information based on cell information. Therefore, the area information based on latitude and longitude needs to be additionally converted into the area information based on cell information.
In manner 1, the UE reports cell information such as the cell ID while reporting location information in the interaction process.
In manner 2: The LMF requests an AMF to convert the location information into information such as the cell ID (steps A1 and A2). An interaction procedure between a device such as the LMF and the UE is performed according to an existing procedure. After the interaction, the LMF obtains the geographic location information, and performs step A1 and step A2.
Step A1: The LMF sends a fifth message to the AMF to request to convert the geographic location information into the cell information. The fifth information includes latitude and longitude location information (to be converted) corresponding to the location correlation data and fourth indication information.
Step A2: After converting the geographic location information into the cell information based on the fifth message, the AMF sends a sixth message to the LMF, and feeds back converted cell information.
Step 404: The LMF selects, based on the first message, location correlation data corresponding to the first area.

Optionally, the LMF selects, based on the area information of the first area and the data filtering information that are in the first message, target data that satisfies a condition, namely, the location correlation data corresponding to the first area.
Step 405: The LMF sends a second message, and feeds back the location correlation data corresponding to the first area to the NWDAF.

Optionally, the LMF sends the second message to the GMLC, and the GMLC sends the second message to the NWDAF, or the like.

Optionally, the LMF directly sends the second message to the NWDAF.
Scenario 3: Area and active collection

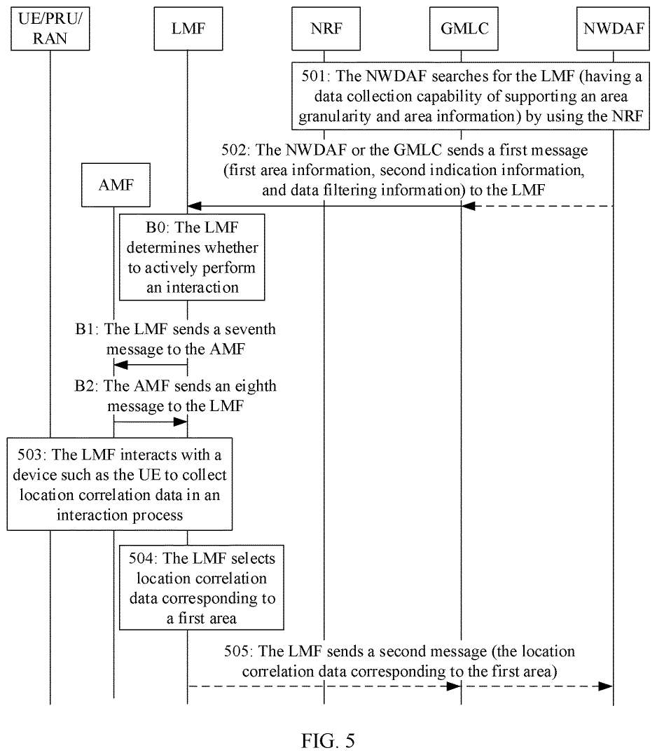

As shown in FIG. 5, a specific implementation procedure includes the following steps.
Step 501: An NWDAF searches for an LMF by using an NRF, to search for an LMF that has a data collection capability of supporting an area granularity and supporting area information (area information based on latitude and longitude, or area information based on cell information). For example, refer to step 301 and step 401.
Step 502: The NWDAF or a GMLC sends a first message to the LMF (a target LMF, or the LMF found in the previous step), where the first message includes area information (the area information based on latitude and longitude, or the area information based on cell information) of a first area, second indication information, and data filtering information.

Optionally, before performing an interaction, if the LMF learns identification information of a target terminal corresponding to the first area, the LMF may collect location correlation data of a corresponding terminal for the identification information of the target terminal in a data collection process, and the collected location correlation data is in the first area. Specifically, step B1 and step B2 are performed.
Step B1: The LMF sends a seventh message to an AMF to request the identification information of the target terminal corresponding to the first area, that is, to convert the area information (the area information based on the latitude and longitude, or the area information based on the cell information) of the first area into a UE ID or the like, so as to interact with a device in the first area.
Step B2: After receiving the seventh message, the AMF determines, based on the seventh message, the identification information of the target terminal corresponding to the first area, and sends an eighth message to the LMF, where the eighth message includes the UE ID in the first area.
Step 503: The LMF interacts with a device such as UE/PRU/RAN to collect location correlation data in an interaction process.

Optionally, before step 503, the LMF performs step B0 to determine whether to actively perform the interaction. The LMF determines, based on the data filtering information and/or the second indication information, whether to actively perform the interaction, and requests identification information of a terminal in the first area from the AMF. For example, the LMF actively performs an immediate or future time interaction for an NWDAF indication. To be specific, in step 502, the first message carries the second indication information; and target time information in the data filtering information is immediate time, future time, a future time period, or the like; or a reporting condition is immediate reporting; or another immediate (instant, immediate) indication or the like is provided.

Optionally, after determining, based on the data filtering information, that the LMF actively performs the interaction, step B1 and step B2 are performed. Specifically, the LMF determines, based on the data filtering information, that the interaction needs to be performed at a moment, so as to send the seventh message to the AMF while collecting the location correlation data, to request the AMF to feed back information such as a UE identifier in the first area. The seventh message may carry the area information corresponding to the first area, and fifth indication information (indication information for requesting conversion, or indication information for requesting the UE identifier in the first area).
Step 504: The LMF selects, based on the first message, location correlation data corresponding to the first area.

Optionally, because the collected location correlation data is in the first area and satisfies a requirement of the area information of the first area, the LMF only needs to select, based on the data filtering information in the first message, target data that satisfies a condition for reporting. If the first message does not carry the data filtering information, step 504 is skipped after step 503 to directly perform step 505.
Step 505: The LMF sends a second message, and feeds back the location correlation data corresponding to the first area to the NWDAF.

Optionally, the LMF sends the second message to the GMLC, and the GMLC sends the second message to the NWDAF, or the like.

Optionally, the LMF directly sends the second message to the NWDAF.
Scenario 4: Registration

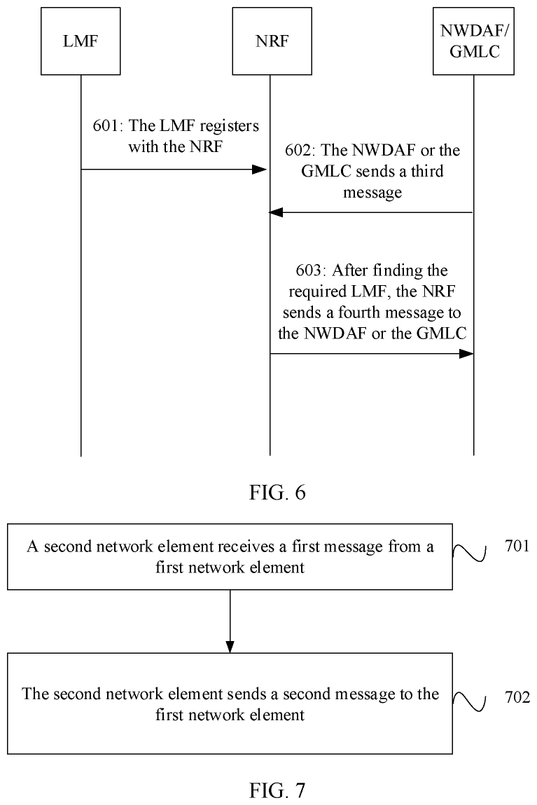

As shown in FIG. 6, a specific implementation procedure includes the following steps.
Step 601: An LMF registers with an NRF.

Optionally, the LMF sends a registration request carrying at least one of the following: first capability information indicating that the LMF has a data collection capability of supporting an area granularity; second capability information indicating that the LMF has a capability of supporting AI positioning; information about an area supported by the LMF; third capability information indicating that the LMF has a capability of supporting active collection; and a time range in which the LMF supports data collection. The registration request is a registration message, and may further include information such as an NF instance ID (an NF instance ID, an FQDN or IP address of NF, or network element instance identification information), an NF type, or a network element type.

Optionally, the LMF may send the registration request by using an Nnrf_NFManagement_NFRegister Register message or the like. After receiving the registration request, the NRF stores information carried in the registration request, and sends a response message (by using an Nnrf_NFManagement_NFRegister response message), to notify the LMF that registration succeeds.
Step 602: An NWDAF or a GMLC sends a third message to the NRF to search for the LMF, to search for an LMF that has a data collection capability of supporting an area granularity and supporting area information (area information based on latitude and longitude, or area information based on cell information).

Optionally, the third message is implemented by using an Nnrf_NFDiscovery_Request service.
Step 603: After finding the required LMF, the NRF sends a fourth message to the NWDAF or the GMLC.

Optionally, the fourth message carries identification information of the LMF, such as the NF instance ID, the FQDN or IP address of NF, or the network element instance identification information.

Optionally, the fourth message is implemented by using an Nnrf_NFDiscovery_Request response.

It should be noted that, in this embodiment of this application, the NWDAF can obtain location correlation data of a specific area at an area granularity from the LMF, thereby improving data obtaining efficiency.

As shown in FIG. 7, a data processing method in an embodiment of this application includes the following steps.
Step 701: A second network element receives a first message from a first network element, where the first message is used to obtain location correlation data corresponding to a first area.
Step 702: The second network element sends a second message to the first network element, where the second message includes the location correlation data corresponding to the first area.

Optionally, the first message includes at least one of the following:
area information of the first area;
first indication information, where the first indication information indicates passive data collection;
second indication information, where the second indication information indicates active data collection;
third indication information, where the third indication information indicates to collect the location correlation data corresponding to the first area;
an area granularity of the first area;
a message type, where the message type includes a subscription message or a request message;
data filtering information, where the data filtering information is used to limit reported location correlation data; and
a reporting condition of the location correlation data.

Optionally, the data filtering information includes at least one of the following:
a target data source type;
target time information; and
a target data type.

Optionally, the second message further includes at least one of the following:
a data type corresponding to the location correlation data;
time information corresponding to the location correlation data;
a data source corresponding to the location correlation data;
area information corresponding to the location correlation data; and
identification information of a terminal.

Optionally, the method further includes:

The second network element sends a fifth message to a fourth network element, where the fifth message is used to request cell information corresponding to the location correlation data.

The second network element receives a sixth message from the fourth network element, where the sixth message includes the cell information corresponding to the location correlation data.

Optionally, the fifth message includes at least one of the following:
location information corresponding to the location correlation data;
a target area granularity; and
fourth indication information, where the fourth indication information indicates to determine the cell information corresponding to the location correlation data.

Optionally, after the second network element receives the first message from the first network element, the method further includes:

The second network element determines to actively collect data, and sends a seventh message to the fourth network element, where the seventh message is used to request identification information of a target terminal corresponding to the first area.

The second network element receives an eighth message from the fourth network element, where the eighth message includes the identification information of the target terminal.

Optionally, the seventh message includes at least one of the following:
the area information corresponding to the first area; and
fifth indication information, where the fifth indication information indicates to determine the identification information of the target terminal.

Optionally, the method further includes:

The second network element sends a registration request to a third network element, where the registration request includes at least one of the following:
first capability information, indicating that the second network element has a data collection capability of supporting an area granularity;
second capability information, indicating that the second network element has a capability of supporting artificial intelligence AI positioning; and
information about an area supported by the second network element.

Optionally, before the second network element sends the second message to the first network element, the method further includes:

The second network element obtains, based on the first message, the location correlation data corresponding to the first area.

It should be noted that all descriptions of the second network element side in the foregoing embodiment are applicable to an embodiment of a data processing method applied to the second network element side, and a same technical effect can also be achieved. Details are not described herein again.

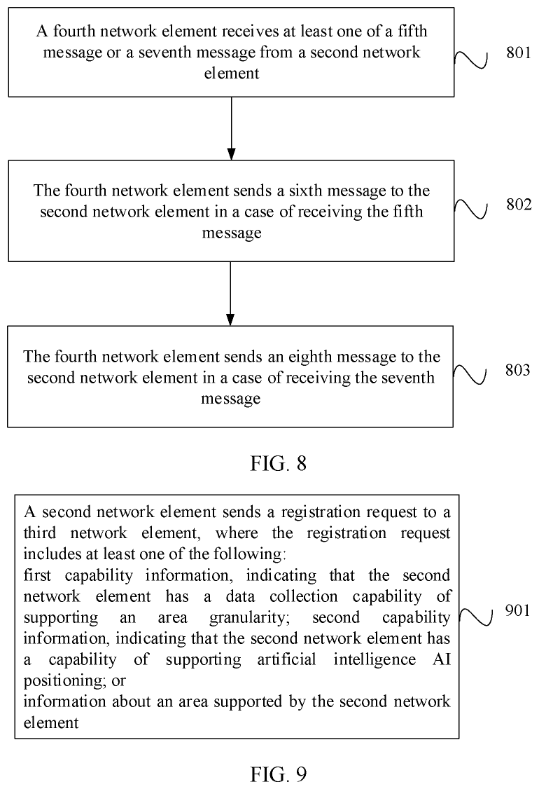

As shown in FIG. 8, an embodiment of this application provides a data processing method, including:
Step 801: A fourth network element receives at least one of a fifth message or a seventh message from a second network element, where the fifth message is used to request cell information of location correlation data corresponding to a first area, and the seventh message is used to request identification information of a target terminal corresponding to the first area.
Step 802: The fourth network element sends a sixth message to the second network element in a case of receiving the fifth message, where the sixth message includes the cell information corresponding to the location correlation data.
Step 803: The fourth network element sends an eighth message to the second network element in a case of receiving the seventh message, where the eighth message includes the identification information of the target terminal.

Optionally, the fifth message includes at least one of the following:
location information corresponding to the location correlation data;
a target area granularity; and
fourth indication information, where the fourth indication information indicates to determine the cell information corresponding to the location correlation data.

Optionally, the seventh message includes at least one of the following:
area information of the first area; and
fifth indication information, where the fifth indication information indicates to determine the identification information of the target terminal.

It should be noted that all descriptions of the fourth network element side in the foregoing embodiment are applicable to an embodiment of a data processing method applied to the fourth network element side, and a same technical effect can also be achieved. Details are not described herein again.

As shown in FIG. 9, an embodiment of this application provides a data processing method, including:
Step 901: A second network element sends a registration request to a third network element, where the registration request includes at least one of the following:
first capability information, indicating that the second network element has a data collection capability of supporting an area granularity;
second capability information, indicating that the second network element has a capability of supporting artificial intelligence AI positioning; and
information about an area supported by the second network element.

It should be noted that all descriptions of the second network element side in the foregoing embodiment are applicable to an embodiment of a data processing method applied to the second network element side, and a same technical effect can also be achieved. Details are not described herein again.

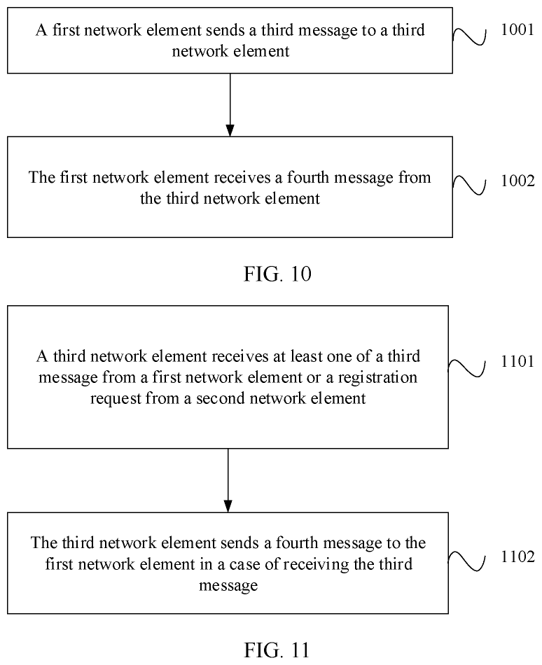

As shown in FIG. 10, an embodiment of this application provides a data processing method, including:
Step 1001: A first network element sends a third message to a third network element, where the third message is used to search for a second network element.
Step 1002: The first network element receives a fourth message from the third network element, where the fourth message includes location information and/or identification information of the second network element.

The second network element is configured to feed back location correlation data corresponding to a first area.

Optionally, the third message includes at least one of the following:
area information of a target network element;
sixth indication information, where the sixth indication information indicates that a target network element needs to have a data collection capability of supporting an area granularity; and
seventh indication information, where the seventh indication information indicates that a target network element needs to have a capability of supporting artificial intelligence AI positioning.

The target network element is a searching target of the third message.

It should be noted that all descriptions of the second network element side in the foregoing embodiment are applicable to an embodiment of a data processing method applied to the second network element side, and a same technical effect can also be achieved. Details are not described herein again.

As shown in FIG. 11, an embodiment of this application provides a data processing method, including:
Step 1101: A third network element receives at least one of a third message from a first network element or a registration request from a second network element. The second network element is configured to feed back location correlation data corresponding to a first area; the third message is used to search for the second network element; and the registration request includes at least one of the following: first capability information, indicating that the second network element has a data collection capability of supporting an area granularity; second capability information, indicating that the second network element has a capability of supporting artificial intelligence AI positioning; and information about an area supported by the second network element.
Step 1102: The third network element sends a fourth message to the first network element in a case of receiving the third message, where the fourth message includes address information and/or identification information of the second network element.

Optionally, the third message includes at least one of the following:
area information of a target network element;
sixth indication information, where the sixth indication information indicates that a target network element needs to have a data collection capability of supporting an area granularity; and
seventh indication information, where the seventh indication information indicates that a target network element needs to have a capability of supporting artificial intelligence AI positioning.

The target network element is a searching target of the third message.

It should be noted that all descriptions of the third network element side in the foregoing embodiment are applicable to an embodiment of a data processing method applied to the third network element side, and a same technical effect can also be achieved. Details are not described herein again.

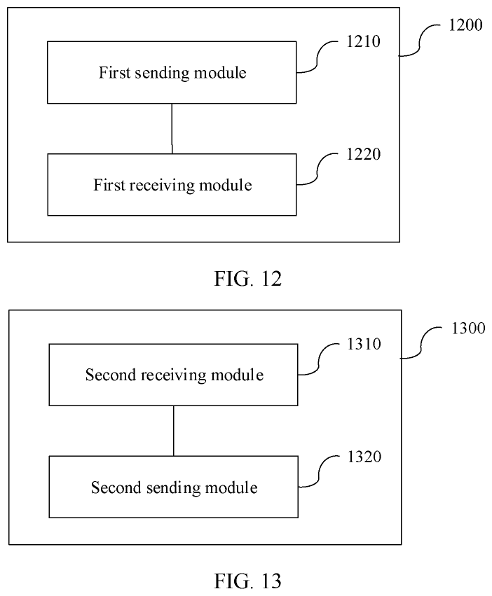

As shown in FIG. 12, a data processing apparatus 1200 in an embodiment of this application is applied to a first network element and includes:
a first sending module 1210, configured to send a first message to a second network element, where the first message is used to obtain location correlation data corresponding to a first area; and
a first receiving module 1220, configured to receive a second message from the second network element, where the second message includes the location correlation data corresponding to the first area.

Optionally, the first message includes at least one of the following:
area information of the first area;
first indication information, where the first indication information indicates passive data collection;
second indication information, where the second indication information indicates active data collection;
third indication information, where the third indication information indicates to collect the location correlation data corresponding to the first area;
an area granularity of the first area;
a message type, where the message type includes a subscription message or a request message;
data filtering information, where the data filtering information is used to limit reported location correlation data; and
a reporting condition of the location correlation data.

Optionally, the data filtering information includes at least one of the following:
a target data source type;
target time information; and
a target data type.

Optionally, the second message further includes at least one of the following:
a data type corresponding to the location correlation data;
time information corresponding to the location correlation data;
a data source corresponding to the location correlation data;
area information corresponding to the location correlation data; and
identification information of a terminal.

Optionally, the apparatus further includes:
a third message sending module, configured to send a third message to a third network element, where the third message is used to search for the second network element; and
a fourth message sending module, configured to receive a fourth message from the third network element, where the fourth message includes address information and/or identification information of the second network element.

Optionally, the third message includes at least one of the following:
area information of a target network element;
sixth indication information, where the sixth indication information indicates that a target network element needs to have a data collection capability of supporting an area granularity; and
seventh indication information, where the seventh indication information indicates that a target network element needs to have a capability of supporting artificial intelligence AI positioning.

The target network element is a searching target of the third message.

Optionally, the first sending module is further configured to: send the first message to the second network element via a fifth network element.

The first receiving module is further configured to: receive the second message from the second network element via the fifth network element.

It should be noted that the apparatus embodiment shows an apparatus corresponding to the foregoing method, all implementations in the foregoing method embodiment are applicable to the apparatus embodiment, and a same technical effect can also be achieved. Details are not described herein again.

As shown in FIG. 13, a data processing apparatus 1300 in an embodiment of this application is applied to a second network element and includes:
a second receiving module 1310, configured to receive a first message from a first network element, where the first message is used to obtain location correlation data corresponding to a first area; and
a second sending module 1320, configured to send a second message to the first network element, where the second message includes the location correlation data corresponding to the first area.

Optionally, the first message includes at least one of the following:
area information of the first area;
first indication information, where the first indication information indicates passive data collection;
second indication information, where the second indication information indicates active data collection;
third indication information, where the third indication information indicates to collect the location correlation data corresponding to the first area;
an area granularity of the first area;
a message type, where the message type includes a subscription message or a request message;
data filtering information, where the data filtering information is used to limit reported location correlation data; and
a reporting condition of the location correlation data.

Optionally, the data filtering information includes at least one of the following:
a target data source type;
target time information; and
a target data type.

Optionally, the second message further includes at least one of the following:
a data type corresponding to the location correlation data;
time information corresponding to the location correlation data;
a data source corresponding to the location correlation data;
area information corresponding to the location correlation data; and
identification information of a terminal.

Optionally, the apparatus further includes: a fifth message sending module, configured to send a fifth message to a fourth network element, where the fifth message is used to request cell information corresponding to the location correlation data; and
a sixth message receiving module, configured to receive a sixth message from the fourth network element, where the sixth message includes the cell information corresponding to the location correlation data.

Optionally, the fifth message includes at least one of the following:
latitude and longitude location information corresponding to the location correlation data;
a target area granularity; and
fourth indication information, where the fourth indication information indicates to determine the cell information corresponding to the location correlation data.

Optionally, the apparatus further includes:
a seventh message sending module, configured to: determine to actively collect data, and send a seventh message to the fourth network element, where the seventh message is used to request identification information of a target terminal corresponding to the first area; and
an eighth message receiving module, configured to receive an eighth message from the fourth network element, where the eighth message includes the identification information of the target terminal.

Optionally, the seventh message includes at least one of the following:
the area information corresponding to the first area; and
fifth indication information, where the fifth indication information indicates to determine the identification information of the target terminal.

Optionally, the apparatus further includes:
a registration request sending module, configured to send a registration request to a third network element, where the registration request includes at least one of the following:
first capability information, indicating that the second network element has a data collection capability of supporting an area granularity;
second capability information, indicating that the second network element has a capability of supporting artificial intelligence AI positioning; and
information about an area supported by the second network element.

Optionally, the apparatus further includes:
an obtaining module, configured to obtain, based on the first message, the location correlation data corresponding to the first area.

It should be noted that the apparatus embodiment shows an apparatus corresponding to the foregoing method, all implementations in the foregoing method embodiment are applicable to the apparatus embodiment, and a same technical effect can also be achieved. Details are not described herein again.

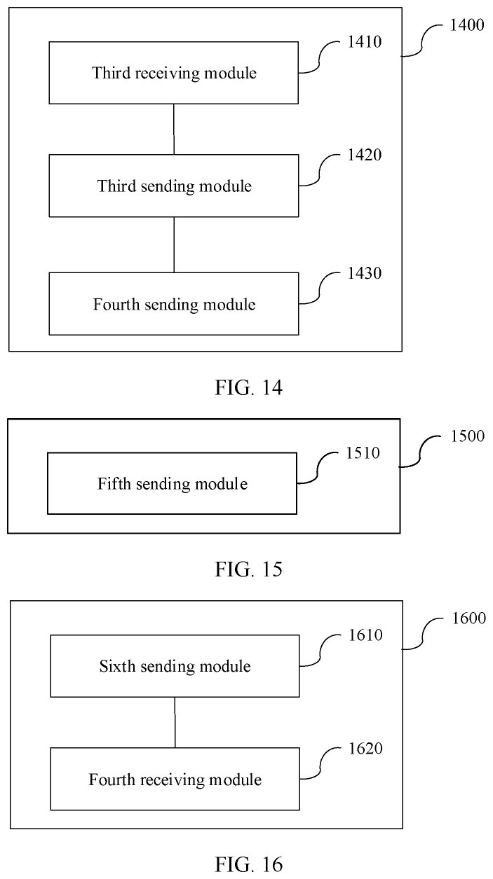

As shown in FIG. 14, a data processing apparatus 1400 in an embodiment of this application is applied to a fourth network element and includes:
a third receiving module 1410, configured to receive at least one of a fifth message or a seventh message from a second network element, where the fifth message is used to request cell information of location correlation data corresponding to a first area, and the seventh message is used to request identification information of a target terminal corresponding to the first area;
a third sending module 1420, configured to send a sixth message to the second network element in a case that the fifth message is received, where the sixth message includes the cell information corresponding to the location correlation data; and
a fourth sending module 1430, configured to send an eighth message to the second network element in a case that the seventh message is received, where the eighth message includes the identification information of the target terminal.

Optionally, the fifth message includes at least one of the following:
latitude and longitude location information corresponding to the location correlation data;
a target area granularity; and
fourth indication information, where the fourth indication information indicates to determine the cell information corresponding to the location correlation data.

Optionally, the seventh message includes at least one of the following:
area information of the first area; and
fifth indication information, where the fifth indication information indicates to determine the identification information of the target terminal.

It should be noted that the apparatus embodiment shows an apparatus corresponding to the foregoing method, all implementations in the foregoing method embodiment are applicable to the apparatus embodiment, and a same technical effect can also be achieved. Details are not described herein again.

As shown in FIG. 15, a data processing apparatus 1500 in an embodiment of this application is applied to a second network element and includes:
a fifth sending module 1510, configured to send a registration request to a third network element, where the registration request includes at least one of the following:
first capability information, indicating that the second network element has a data collection capability of supporting an area granularity;
second capability information, indicating that the second network element has a capability of supporting artificial intelligence AI positioning; and
information about an area supported by the second network element.

It should be noted that the apparatus embodiment shows an apparatus corresponding to the foregoing method, all implementations in the foregoing method embodiment are applicable to the apparatus embodiment, and a same technical effect can also be achieved. Details are not described herein again.

As shown in FIG. 16, a data processing apparatus 1600 in an embodiment of this application is applied to a first network element and includes:
a sixth sending module 1610, configured to send a third message to a third network element, where the third message is used to search for a second network element; and
a fourth receiving module 1620, configured to receive a fourth message from the third network element, where the fourth message includes address information and/or identification information of the second network element.

The second network element is configured to feed back location correlation data corresponding to a first area.

Optionally, the third message includes at least one of the following:
area information of a target network element;
sixth indication information, where the sixth indication information indicates that a target network element needs to have a data collection capability of supporting an area granularity; and
seventh indication information, where the seventh indication information indicates that a target network element needs to have a capability of supporting artificial intelligence AI positioning.

The target network element is a searching target of the third message.

It should be noted that the apparatus embodiment shows an apparatus corresponding to the foregoing method, all implementations in the foregoing method embodiment are applicable to the apparatus embodiment, and a same technical effect can also be achieved. Details are not described herein again.

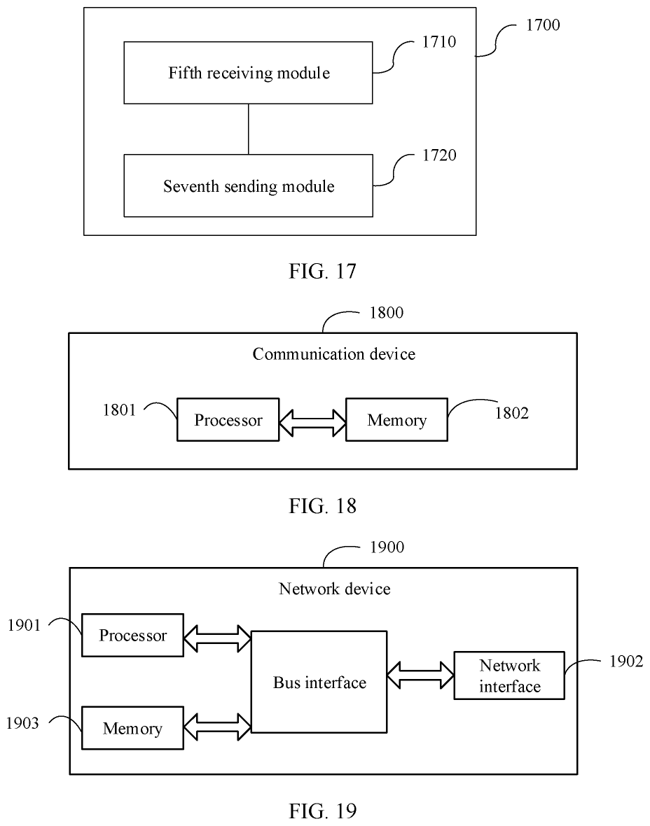

As shown in FIG. 17, a data processing apparatus 1700 in an embodiment of this application is applied to a third network element and includes:
a fifth receiving module 1710, configured to receive at least one of a third message from a first network element or a registration request from a second network element, where the second network element is configured to feed back location correlation data corresponding to a first area; the third message is used to search for the second network element; and the registration request includes at least one of the following: first capability information, indicating that the second network element has a data collection capability of supporting an area granularity; second capability information, indicating that the second network element has a capability of supporting artificial intelligence AI positioning; and information about an area supported by the second network element; and
a seventh sending module 1720, configured to send a fourth message to the first network element in a case that the third message is received, where the fourth message includes address information and/or identification information of the second network element.

Optionally, the third message includes at least one of the following:
area information of a target network element;
sixth indication information, where the sixth indication information indicates that a target network element needs to have a data collection capability of supporting an area granularity; and
seventh indication information, where the seventh indication information indicates that a target network element needs to have a capability of supporting artificial intelligence AI positioning.

The target network element is a searching target of the third message.

It should be noted that the apparatus embodiment shows an apparatus corresponding to the foregoing method, all implementations in the foregoing method embodiment are applicable to the apparatus embodiment, and a same technical effect can also be achieved. Details are not described herein again.

As shown in FIG. 18, an embodiment of this application further provides a communication device 1800, including a processor 1801 and a memory 1802. The memory 1802 stores a program or instructions are executable by the processor 1801. For example, when the communication device 1800 is a network device, the program or the instructions are executed by the processor 1801 to implement the steps in the foregoing data processing method embodiments, and a same technical effect can be achieved. To avoid repetition, details are not described herein again.

An embodiment of this application further provides a network device, including a processor and a communication interface. The communication interface is coupled to the processor. The processor is configured to run a program or instructions to implement the steps in the method embodiments shown in FIG. 2, FIG. 7, FIG. 8, FIG. 9, FIG. 10, and FIG. 11. The network device embodiment corresponds to the foregoing data processing method embodiment applied to the first network element, the second network element, the third network element, or the fourth network element. Each implementing process and implementation of the foregoing method embodiment are applicable to the network device embodiment, and a same technical effect can be achieved.

Specifically, an embodiment of this application further provides a network device. As shown in FIG. 19, the network device 1900 includes a processor 1901, a network interface 1902, and a memory 1903. The network interface 1902 is, for example, a common public radio interface (CPRI).

Specifically, the network device 1900 in this embodiment of this application further includes instructions or a program stored in the memory 1903 and are executable by the processor 1901. The processor 1901 invokes the instructions or the program in the memory 1903 to perform the method performed by the modules shown in FIG. 12, FIG. 13, FIG. 14, FIG. 15, FIG. 16, or FIG. 17, and a same technical effect is achieved. To avoid repetition, details are not described herein again.

An embodiment of this application further provides a readable storage medium. The readable storage medium stores a program or instructions. The program or the instructions are executed by a processor to implement the processes in the foregoing data processing method embodiment, and a same technical effect can be achieved. To avoid repetition, details are not described herein again.

The processor is a processor in the terminal described in the foregoing embodiments. The readable storage medium includes a computer-readable storage medium, for example, a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or instructions to implement the processes in the foregoing data processing method embodiment, and a same technical effect can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes in the foregoing data processing method embodiment, and a same technical effect can be achieved. To avoid repetition, details are not described herein again.

An embodiment of this application further provides a wireless communication system, including a first network element, a second network element, a third network element, and a fourth network element. The first network element may be configured to perform the steps of the foregoing data processing method, the second network element may be configured to perform the steps of the foregoing data processing method, the third network element performs the steps of the foregoing data processing method, and the fourth network element performs the steps of the foregoing data processing method.

It should be noted that in this specification, the term “include”, “contain”, or any of their variants is intended to cover a non-exclusive inclusion, so that a process, method, article, or apparatus that includes a list of elements not only includes those elements but also includes other elements that are not expressly listed, or further includes elements inherent to such a process, method, article, or apparatus. Without more constraints, an element preceded by “includes a...” does not preclude the existence of additional identical elements in the process, method, article, or apparatus that includes the element. In addition, it should be noted that the scope of the method and apparatus in the implementations of this application is not limited to performing functions in an order shown or discussed, and may further include performing functions in a basically simultaneous manner or in a reverse order based on the functions involved. For example, the described method may be performed in an order different from the described order, and various steps may be added, omitted, or combined. In addition, features described with reference to some examples can be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for enabling a terminal or a network device to perform the methods described in the embodiments of this application.

The foregoing describes embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

1. A data processing method, comprising:
sending, by a first network element, a first message to a second network element, wherein the first message is used to obtain location correlation data corresponding to a first area; and
receiving, by the first network element, a second message from the second network element, wherein the second message comprises the location correlation data corresponding to the first area.

2. The method according to claim 1, wherein the first message comprises at least one of the following:
area information of the first area;
first indication information, wherein the first indication information indicates passive data collection;
second indication information, wherein the second indication information indicates active data collection;
third indication information, wherein the third indication information indicates to collect the location correlation data corresponding to the first area;
an area granularity of the first area;
a message type, wherein the message type comprises a subscription message or a request message;
data filtering information, wherein the data filtering information is used to limit reported location correlation data; or
a reporting condition of the location correlation data.

3. The method according to claim 2, wherein the data filtering information comprises at least one of the following:
a target data source type;
target time information; or
a target data type.

4. The method according to claim 1, wherein before the sending, by a first network element, a first message to a second network element, the method further comprises:
sending, by the first network element, a third message to a third network element, wherein the third message is used to search for the second network element; and
receiving, by the first network element, a fourth message from the third network element, wherein the fourth message comprises location information and/or identification information of the second network element.

5. The method according to claim 4, wherein the third message comprises at least one of the following:
area information of a target network element;
sixth indication information, wherein the sixth indication information indicates that a target network element needs to have a data collection capability of supporting an area granularity; or
seventh indication information, wherein the seventh indication information indicates that a target network element needs to have a capability of supporting artificial intelligence (AI) positioning, wherein
the target network element is a searching target of the third message.

6. A data processing method, comprising:
receiving, by a second network element, a first message from a first network element, wherein the first message is used to obtain location correlation data corresponding to a first area; and
sending, by the second network element, a second message to the first network element, wherein the second message comprises the location correlation data corresponding to the first area.

7. The method according to claim 6, wherein the first message comprises at least one of the following:
area information of the first area;
first indication information, wherein the first indication information indicates passive data collection;
second indication information, wherein the second indication information indicates active data collection;
third indication information, wherein the third indication information indicates to collect the location correlation data corresponding to the first area;
an area granularity of the first area;
a message type, wherein the message type comprises a subscription message or a request message;
data filtering information, wherein the data filtering information is used to limit reported location correlation data; or
a reporting condition of the location correlation data.

8. The method according to claim 7, wherein the data filtering information comprises at least one of the following:
a target data source type;
target time information; or
a target data type.

9. The method according to claim 6, further comprising:
sending, by the second network element, a fifth message to a fourth network element, wherein the fifth message is used to request cell information corresponding to the location correlation data; and
receiving, by the second network element, a sixth message from the fourth network element, wherein the sixth message comprises the cell information corresponding to the location correlation data.

10. The method according to claim 9, wherein the fifth message comprises at least one of the following:
latitude and longitude location information corresponding to the location correlation data;
a target area granularity; or
fourth indication information, wherein the fourth indication information indicates to determine the cell information corresponding to the location correlation data.

11. The method according to claim 6, wherein after the receiving, by a second network element, a first message from a first network element, the method further comprises:
determining, by the second network element, to actively collect data, and sending a seventh message to the fourth network element, wherein the seventh message is used to request identification information of a target terminal corresponding to the first area; and
receiving, by the second network element, an eighth message from the fourth network element, wherein the eighth message comprises the identification information of the target terminal.

12. The method according to claim 11, wherein the seventh message comprises at least one of the following:
the area information corresponding to the first area; or
fifth indication information, wherein the fifth indication information indicates to determine the identification information of the target terminal.

13. The method according to claim 6, further comprising:
sending, by the second network element, a registration request to a third network element, wherein the registration request comprises at least one of the following:
first capability information, indicating that the second network element has a data collection capability of supporting an area granularity;
second capability information, indicating that the second network element has a capability of supporting artificial intelligence AI positioning; or
information about an area supported by the second network element.

14. The method according to claim 6, wherein before the sending, by the second network element, a second message to the first network element, the method further comprises:
obtaining, by the second network element based on the first message, the location correlation data corresponding to the first area.

15. A data processing method, comprising:
receiving, by a fourth network element, at least one of a fifth message or a seventh message from a second network element, wherein the fifth message is used to request cell information of location correlation data corresponding to a first area, and the seventh message is used to request identification information of a target terminal corresponding to the first area;
sending, by the fourth network element, a sixth message to the second network element in a case of receiving the fifth message, wherein the sixth message comprises the cell information corresponding to the location correlation data; and
sending, by the fourth network element, an eighth message to the second network element in a case of receiving the seventh message, wherein the eighth message comprises the identification information of the target terminal.

16. The method according to claim 15, wherein the fifth message comprises at least one of the following:
latitude and longitude location information corresponding to the location correlation data;
a target area granularity; or
fourth indication information, wherein the fourth indication information indicates to determine the cell information corresponding to the location correlation data.

17. The method according to claim 15, wherein the seventh message comprises at least one of the following:
area information of the first area; or
fifth indication information, wherein the fifth indication information indicates to determine the identification information of the target terminal.

18. A data processing apparatus, comprising a processor implemented in hardware and a memory, wherein the memory stores a program or instructions are executable by the processor and, when the program or the instructions are executed by the processor, the data processing method according to claim 1 is implemented.

19. A data processing apparatus, comprising a processor implemented in hardware and a memory, wherein the memory stores a program or instructions are executable by the processor and, when the program or the instructions are executed by the processor, the data processing method according to claim 6 is implemented.

20. A data processing apparatus, comprising a processor implemented in hardware and a memory, wherein the memory stores a program or instructions are executable by the processor and, when the program or the instructions are executed by the processor, the data processing method according to claim 15 is implemented.
